(19) United States
(12) Patent Application Publication
(10) Pub. No.: US 2018/0072091 A1
(43) Pub. Date: Mar. 15, 2018

(54) PENCIL POCKET AND METHOD

(71) Applicant: Rae Ann McDonald, Canfield, OH (US)

(72) Inventor: Rae Ann McDonald, Canfield, OH (US)

(21) Appl. No.: 15/702,728

(22) Filed: Sep. 12, 2017

Related U.S. Application Data
(60) Provisional application No. 62/393,589, filed on Sep. 12, 2016.

(51) Int. Cl. B43K 23/00

(52) U.S. Cl. CPC B43K 23/002

(57) ABSTRACT

A pocket includes a body having a front side and a back side. The back side of the pocket has an adhesive material disposed over the back face. The adhesive material is covered by a removable wrapper that when removed exposes the adhesive on the back of the pocket. The pocket may then be secured to flat surface of a notebook, binder or the like by pressing the adhesive material into said surface. The pocket has a cavity that is accessible through an opening on the front side of the body. A stretchable lanyard cord is removably connected to the bottom of the pocket through a reinforced opening. The stretchable cord has a band at the distal end to receive a writing utensil. The pencil pocket is useful for tethering a writing utensil to a surface for easy access.

### CROSS-REFERENCE TO RELATED APPLICATION(S)

The present application is related to and claims priority to U.S. Provisional Patent Application No. 62/393,589 filed Sep. 12, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pockets of existing art and more specifically relates to pencil and pen pockets.

### RELATED ART

When a student enters the school system at an early age, a number of mandatory supplies may become overwhelming to keep track of. Young students are required to bring pencils, a writing medium such as paper or a notebook, and other materials related to the course work. However, many students are burdened with mental disorders such as attention deficit hyperactivity disorder (ADHD) which impede their organizational abilities. Given that pencils, and like writing utensils, are imperative to academic performance, a student's ability to retain their pencil throughout the day directly correlates to their scholastic success.

Lending out a pencil and not having it returned is a familiar memory to every person who has been enrolled in an academic institution. Further, memories may include frantically digging through a backpack in search of a pencil. Even further memories may include borrowing a pencil from a classmate, or purchasing more to only have them disappear again. Due to the fluid nature of ownership regarding writing utensils in academic institutions, a suitable solution for retaining at least one pencil is desired.

U.S. Pat. No. 2,518,989 to Haslup Dodson relates to a pen and pencil holder. The described pen and pencil holder includes a holder that is adapted to be secured to the cover of a notebook or pad, or to some other book, which holder is adapted to efficiently retain pencils and pens, so that they are always available when needed. Another important object of the invention is to provide a pen and pencil holder which, when secured to a notebook or the like, will not interfere in any way with the regular use of the notebook, and will not jam in the notebook, or otherwise require special formation of the book.

### SUMMARY OF THE INVENTION

In view of the foregoing disadvantages inherent in the known writing utensil holder art, the present disclosure provides a novel pencil pocket. The general purpose of the present disclosure, which will be described subsequently in greater detail, is to provide a pocket for retaining a writing utensil.

A pocket is disclosed herein. The pocket includes a body having a front side and a back side, and a hollow cavity with the opening to the hollow cavity accessible on the front. An adhesive material is coupled to said back side with a removable backing covering the adhesive on the back. Removing the backing exposes the adhesive coupled to the back side of the body. A stretchable cord is connected through a circular hole at the bottom of the pocket on one end, and on the other is connected to a writing utensil.

According to another embodiment, a method of using a pocket to retain a writing utensil is also disclosed herein. The method of using a pocket to retain a writing utensil includes providing the device, removing a disposable backing from a back side of a pocket, wherein removing disposable backing exposes an adhesive material on said back side of the pocket, aligning said back side of the pocket to a desired surface, and applying pressure to a front side of said pocket thereby securing the pocket in place. A writing utensil is then attached to the stretchable cord and then inserted into the pocket.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein, without necessarily achieving other advantages, as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pencil pocket and method, constructed and operative according to the teachings of the present disclosure.

FIG. 1 is a front view of the pocket of FIG. 1, according to an embodiment of the disclosure.

FIG. 2 is a back view of the pocket of FIG. 1, according to an embodiment of the present disclosure.

FIG. 3 is an in-use view of the pocket of FIG. 1, according to an embodiment of the present disclosure.

FIG. 4 is an in-use view of the pocket of FIG. 1, according to an embodiment of the present disclosure.

FIG. 5 is a flow diagram illustrating a method of retaining a writing utensil, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pocket and more particularly to a pencil pocket and method as used to improve the retaining of a writing utensil.

Generally, pencil pocket as disclosed herein is an adhesive pocket that attaches to a book or notebook and is designed to hold a pencil. The pocket measures approximately one and a half inches by eight inches. It is made using a thin material with decorative pattern, such as plastic and an adhesive material. It has a removable backing to expose the adhesive portion. The pocket is formed from the material on the front side, while the adhesive is on the backside. This allows the pocket portion to be adhered to a surface. At the bottom of the pocket portion is a reinforced opening. A stretchable cord is attached to the opening. The cord is approximately twenty inches long. The end of the cord has an adhesive band that attaches to the pencil. The cord can be wrapped around the book or notebook or also used as a bookmark when the pencil is resting in the pocket. The cord is long enough that the pencil can be used comfortably while attached. The cord prevents the student from losing the pencil or having it taken by another student. Each notebook or textbook may have a separate pocket and pencil.

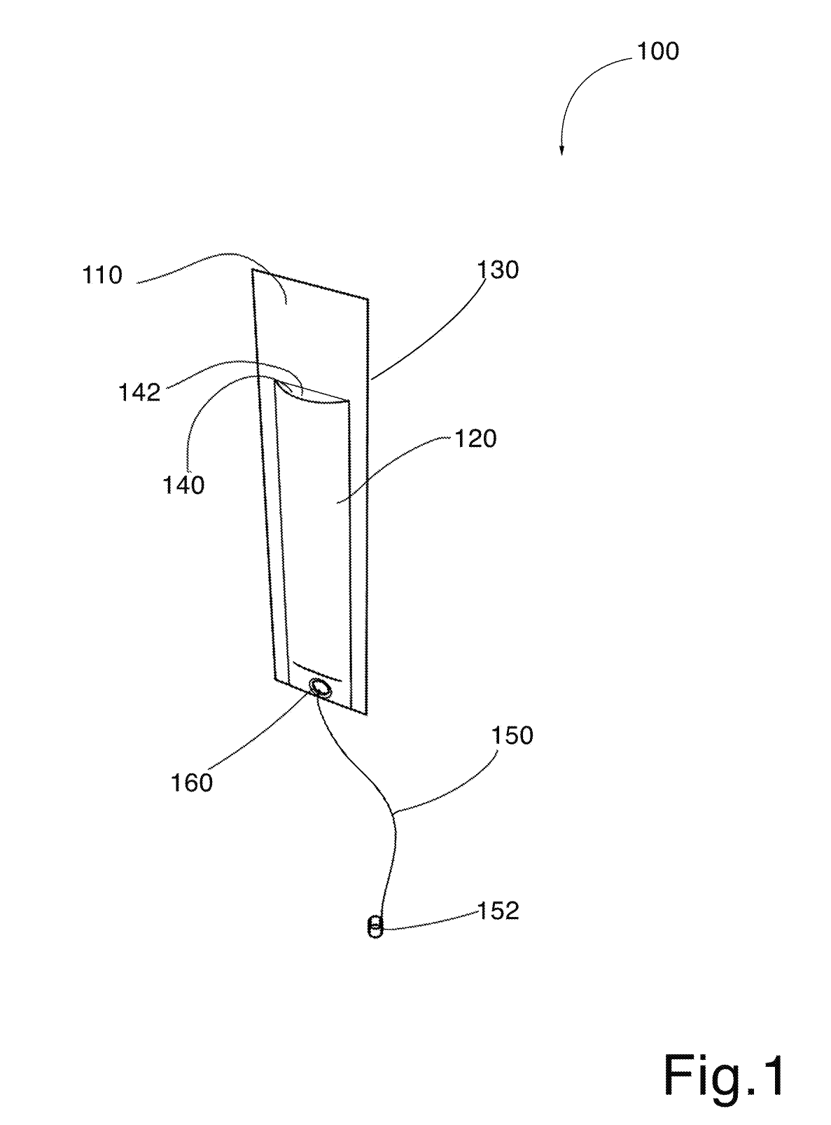

Referring now more specifically to the drawings by numerals of reference, there is shown in FIGS. 1-4, various views of a pocket 100.

FIG. 1 shows a front view of a pocket 100, according to an embodiment of the present disclosure. Here, the pocket 100 may be beneficial for use by a user to retain a writing utensil. As illustrated, the pocket 100 may include a body 110; the body 100 having a front side 120, a back side 130. A hollow cavity 140 located between the body 110 and the front side 120, the hollow cavity 140 having an opening 142. A stretchable cord 150, the stretchable cord 150 being removably attached to a circular opening 160 on the body 110. The distal end of the stretchable cord 150 is coupled to a band 152.

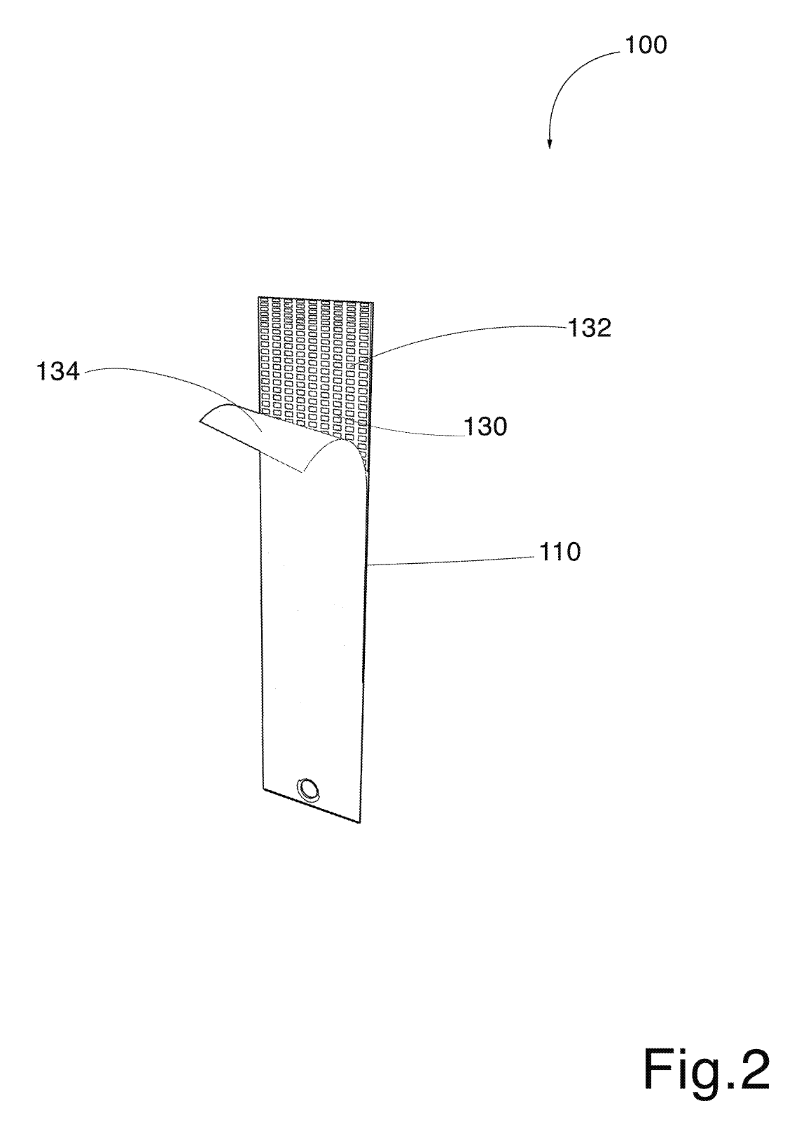

FIG. 2 shows a rear view of the pocket 100 of FIG. 1, according to an embodiment of the present disclosure. As above, the pocket 100 includes a back side 130 with a coupled adhesive material 132 disposed over the back side 130. A removable backing 134, the removable backing 134 being coupled to the back side 130 of the body 110. The adhesive material 132 is covered by the removeable backing 134. Removing of the removable backing 134 exposes the adhesive material 132 coupled to the back side 130 of the body 110.

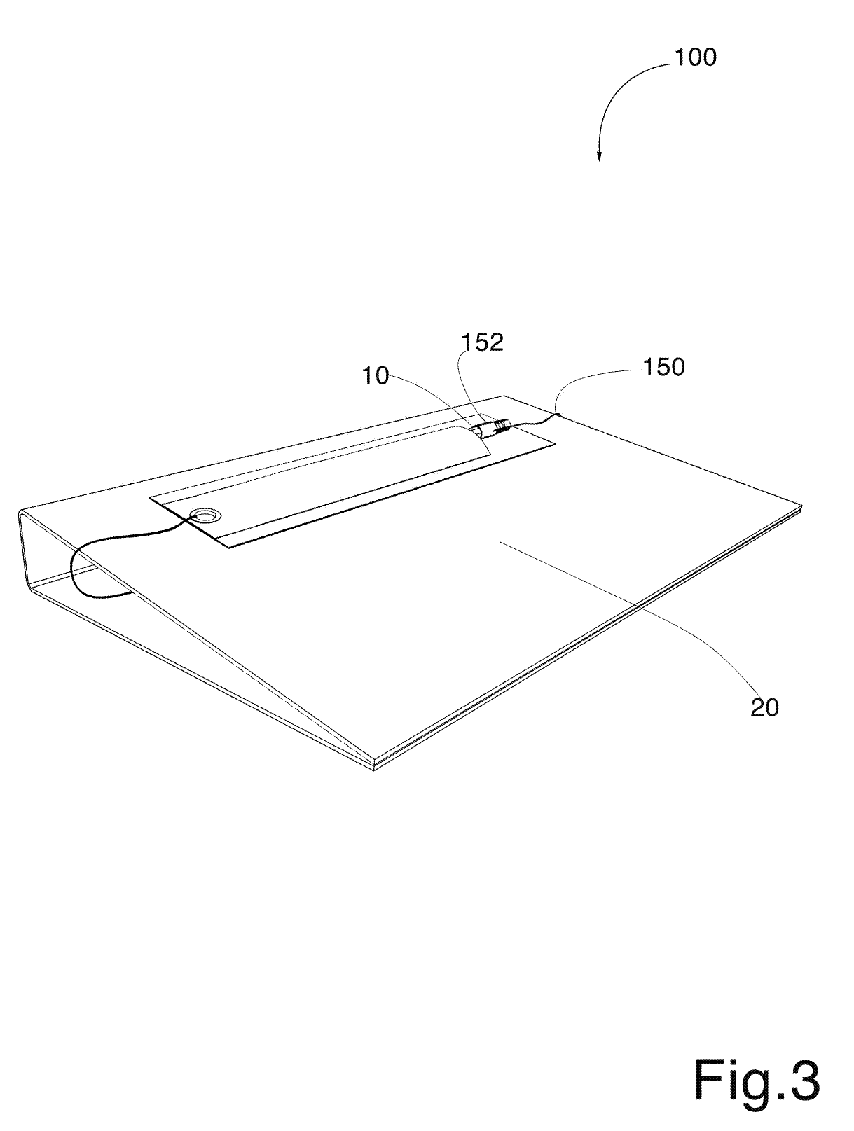

FIG. 3 shows a pocket 100 during an ‘in-use’ condition, according to an embodiment of the present disclosure. This figure illustrates the pocket 100 connected to a surface 20. The distal end of the stretchable cord 150 is coupled to a band 152 which connects to a writing utensil 10. The stretchable cord 150 is wrapped completely around a binder. The pocket 100 is configured to be attached to the surface 20.

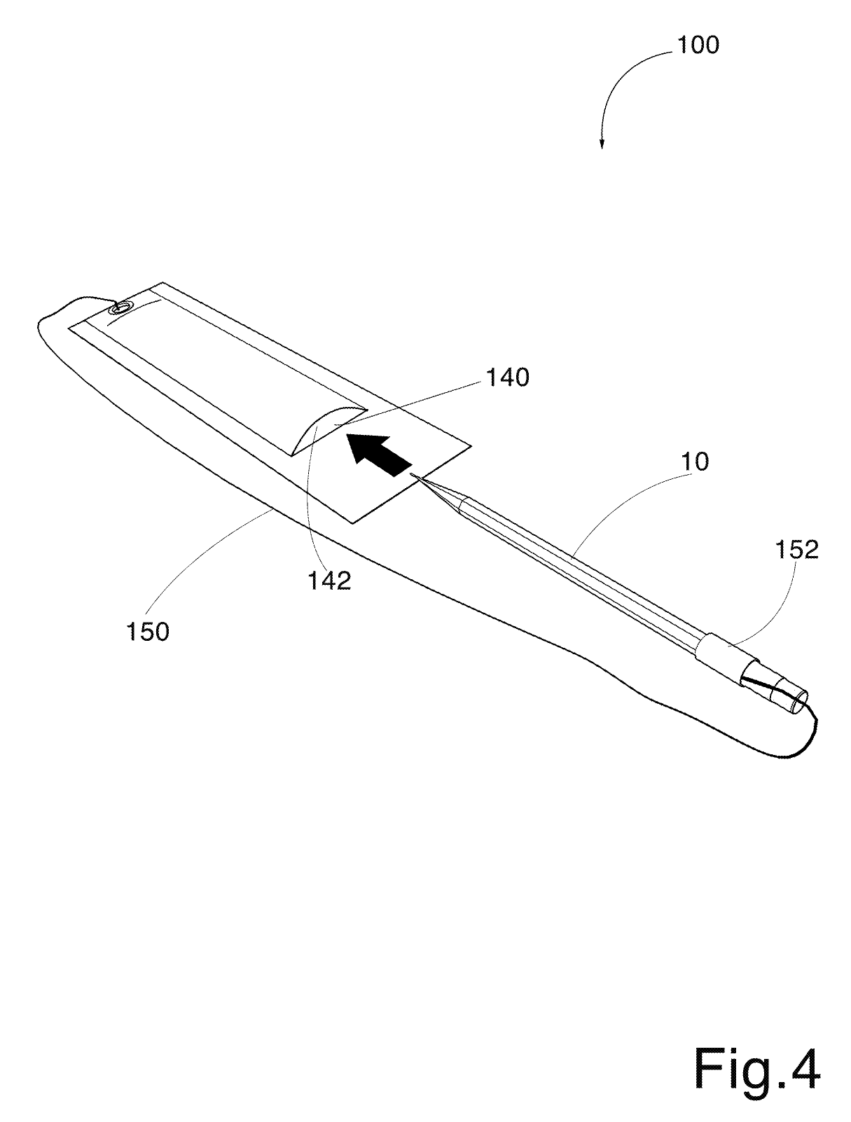

FIG. 4 shows a pocket 100 during an ‘in-use’ condition, according to an embodiment of the present disclosure. This figure illustrates the pocket 100, wherein the opening 142 of the cavity 140 is set to receive the writing utensil 10. Further this figure illustrates how the writing utensil 10 is received by the utensil connection band 152 at the distal end of the stretchable cord 150.

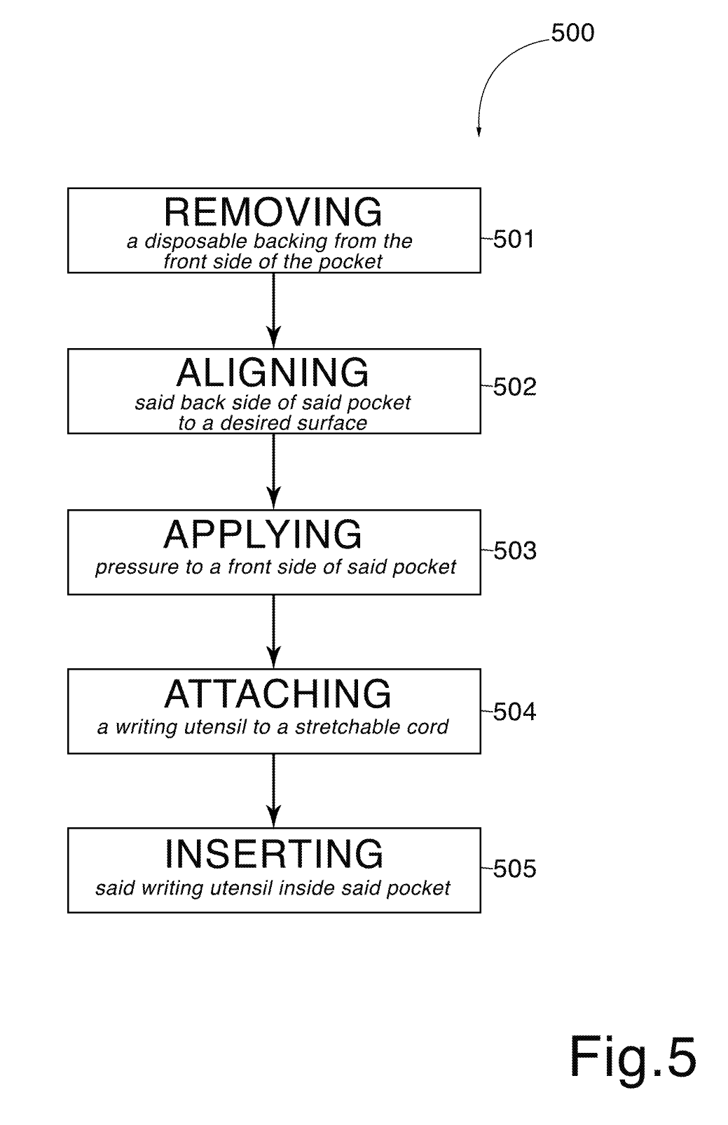

FIG. 5 is a flow diagram illustrating a method 500 for retaining a writing utensil with the pocket 100, according to an embodiment of the present disclosure. In particular, the method 500 for retaining a writing utensil with the pocket 100 may include one or more components or features of the pocket 100 as described above. As illustrated, the method 500 for retaining a writing utensil with the pocket 100 may include the steps of: step one 501, removing a disposable backing from the back side of the pocket, wherein removing the disposable backing from the back side of the pocket exposes a first adhesive material on the back side of said pocket; step two 502, aligning said back side of the pocket to a desired surface; step three 503, applying pressure to a front side of the pocket; step four 504, attaching a writing utensil to a stretchable cord; step five 505, inserting the writing utensil inside the pocket.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for retaining a writing utensil with the pocket 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pocket for retaining a writing utensil comprising:
a body, said body having a front side, a back side, and a hollow cavity, said hollow cavity having an opening;
a first adhesive material, said first adhesive material being coupled to said back side of said body;
a removable backing, said removable backing being coupled to said back side of said body, wherein removing the backing exposes said back side of said body;
a stretchable cord, said stretchable cord being removably attached to said body; and
wherein said pocket is configured to store said writing utensil and be attached to a surface.

2. The pocket of claim 1, wherein said pocket is approximately 1.5 inches wide and 8 inches long.

3. The pocket of claim 1, wherein said back side of said body extends past said opening of said cavity.

4. The pocket of claim 1, wherein said opening of said cavity is on said front side of said body.

5. The pocket of claim 1, wherein said stretchable cord is approximately 20 inches long.

6. The pocket of claim 1, further comprising a lower end of said body, said lower end of said body having a circular opening.

7. The pocket of claim 6, wherein said circular opening is configured to receive said stretchable cord.

8. The pocket of claim 6, wherein the circular opening is reinforced around a circumference of said circular opening.

9. The pocket of claim 1, further comprising a distal end of said stretchable cord, said distal end being coupled to a band.

10. The pocket of claim 9, wherein said band is removably attached to a writing utensil.

11. A pocket for retaining a writing utensil comprising:
a body, said body having a front side, a back side, and a hollow cavity, said hollow cavity having an opening;
a first adhesive material, said first adhesive material being coupled to said back side of said body;
a removable backing, said removable backing being coupled to said back side of said body, wherein removing the backing exposes said back side of said body;
a stretchable cord, said stretchable cord being removably attached to said body;
and wherein said pocket is configured to store a writing utensil and be attached to a surface;
wherein said pocket is approximately 1.5 inches wide and 8 inches long;
wherein said back side of said body extends past said opening of said cavity;
wherein said opening of said cavity is on said front side of said body;
wherein said stretchable cord is approximately 20 inches long;
wherein said body further comprising a lower end of said body;
wherein said lower end of said body having a circular opening;
wherein said circular opening is configured to receive said stretchable cord;
wherein the circular opening is reinforced around a circumference of said circular opening;
further comprising a distal end of said stretchable cord, said distal end being coupled to a band; and
wherein said band is removably attached to said writing utensil;

12. A method of using a pocket, said method comprising the steps of:
removing a disposable backing from a back side of a pocket, wherein removing said disposable backing from said back side of said pocket exposes a first adhesive material on said back side of said pocket;
aligning said back side of said pocket to a desired surface;
applying pressure to a front side of said pocket;
attaching a writing utensil to a stretchable cord, said stretchable cord being removably attached to said pocket; and
inserting said writing utensil inside said pocket.
